(19) United States
(12) Patent Application Publication
(10) Pub. No.: US 2004/0118669 A1
(43) Pub. Date: Jun. 24, 2004

(54) Gaming machine illuminated push-button switch

(76) Inventor: Oliver C. Mou, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/731,646

(22) Filed: Dec. 8, 2003

Related U.S. Application Data
(63) Continuation-in-part of application No. 10/364,535, filed on Feb. 10, 2003.
Application No. 10/364,535 is a continuation-in-part of application No. 09/804,701, filed on Mar. 12, 2001, now Pat. No. 6,590,176.

(51) Int. Cl. H01H 9/00

(52) U.S. Cl. 200/310

(57) ABSTRACT

A gaming machine illuminated push-button switch includes a body for mounting to the gaming machine. A switch is mounted to the body. A push-button is movably supported by the body. An actuator is configured to actuate the switch in response to movement of the push-button. The body is configured to accept a lamp and provide power to inputs of the lamp. The lamp includes a light emitting element and a polarity matching module. When power is applied to the inputs of the lamp, the light emitting element illuminates part of the switch. In one embodiment, the light emitting element is a light emitting diode and the polarity matching module comprises a diode bridge. In one embodiment, diodes of the bridge are associated with a circuit board which is located in a housing of the lamp.

### RELATED APPLICATION DATA

This application is a continuation-in-part of U.S. application Ser. No. 10/364,535, filed Feb. 10, 2003, which is a continuation-in-part of U.S. application Ser. No. 09/804,701, filed Mar. 12, 2001, now U.S. Pat. No. 6,590,176.

### FIELD OF THE INVENTION

The present invention relates to gaming machines, and in particular, illuminated push-button type switches used to operate such machines.

### BACKGROUND OF THE INVENTION

Push-button type switches are often utilized as an input device for a gaming machine. For example, a gaming machine may include a plurality of push-buttons permitting a user to indicate a input, such as to “hold” a card, place a “bet” of a monetary amount, “deal” cards or the like.

In the gaming machine environment, the push-buttons are generally mounted to a portion of the gaming machine housing, such as a metal panel. One problem with these buttons is that they are subject to electrostatic discharge (ESD). A user of the machine may carry an electric charge, such as developed by walking across carpeting in a casino. When the user touches a button of the gaming machine, the path to ground through the button is through the electrical circuitry thereof, including the switch. Thus, the ESD is released through the circuitry of the button. This discharge may harm the switch of the button and may even travel through the gaming machine circuitry to a controller, such as a gaming machine processor. The discharge may damage this circuitry or interfere with the operating of the game for a short period of time. In either event, the discharge causes harm.

During the lifetime of the gaming machine, the buttons of the machine may be used tens of thousands of times. It is therefore important to provide a push-button switch which will accept a high duty cycle and has a long-life. Among other things, components of a button may need to be replaced in order to maintain the button, or else the entire button must be replaced.

In many instances, gaming machines are located in areas of reduced illumination. The reduced illumination makes it easier for a player of the game to view information presented on a video display of the gaming machine. On the other hand, the reduced illumination makes it difficult for a player to observe other aspects of the gaming machine, such as the location of push-buttons. As a result, these switches often include an incandescent lamp or light which illuminates a press-button portion of the switch. These lamps or lights are generally continuously illuminated. During the life of the switch, the lamp or light may burn out numerous times and need to be replaced.

An improved gaming machine illuminated push-button switch is desired.

### SUMMARY OF THE INVENTION

The present invention is a user-operable push-button type switch for use with a gaming machine. The switch is illuminated by an LED lamp including a polarity matching module.

In one embodiment, the push-button electrical switch includes a body having a first end and a second end. An actuator is associated with the body. A push-button is mounted to the actuator and extends from the first end of the body. An electrical switch is provided having a switch button for activating the switch. A mount is adapted to support a lamp and the electrical switch. The mount is connected to the body.

In one embodiment, the body includes at least one latch extending outwardly from the bottom end of the body in a direction generally opposite the top end. The mount includes a surface for engagement by the at least one latch for connecting the mount to the body in position such that movement of the actuator with the push-button causes the switch button to be activated.

In one embodiment, two latches extend outwardly from stop segments located in an interior area of the body at its bottom end. The mount includes a passage through which one of the latches extends, and a recessed or cut-away area along which the other latch extends. The latches both include catches which engage a bottom surface of a main portion of the mount when the mount is engaged with the body. The latches are moveable to a position in which the catches are released, allowing the mount to be disconnected from the body, such as for replacement of the lamp.

In one embodiment, at least a portion of the body adjacent the push-button is transparent and illuminated by the lamp. In one embodiment, the body includes a wall defining a cavity at its top end. The push-button is located at least partially in the cavity. The wall includes a flange which extends outwardly from the push-button, this flange being illuminated. In one embodiment, the lamp is located in an interior portion of the body. The entire body is transparent, transmitting light emitted by the lamp, including to the areas of the body adjacent the push-button.

In one embodiment, the lamp of the switch comprises a polarity matching module having an input and an output leading to a light emitting element. In a preferred configuration, the polarity matching module comprises a diode bridge and the light emitting element comprises a light emitting diode.

In one embodiment, the lamp includes a base supporting a circuit board mounted in a housing, and supporting the light emitting diode mounted within a cover. Diodes of the bridge are associated with a circuit board. The inputs comprise leads, the leads extending from the diode bridge to a point exterior the housing. In one embodiment, a resistor is located along one of the leads.

In a reduced profile configuration, the diodes are mounted to or located at a first side of the circuit board and the resistor is located at a second or opposing side of the circuit board. The cover is a transparent or translucent body located over the light-emitting diode.

In accordance with the preferred embodiment of the lamp, the lamp includes a polarity matching circuit ensuring that the light-emitting diode will illuminate regardless of how the inputs of the lamp are connected to a power supply. In other words, regardless of the polarity of the power supply contacts (such as contacts at a socket of the switch), the polarity matching module ensures that the output polarity is constant and configured to illuminate the light.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming machine including illuminated push-button electrical switches of the invention;

FIG. 2 is a side view of a push-button electrical switch of the invention mounted to a support structure in the form of a gaming machine housing;

FIG. 3 is an exploded view of the push-button electrical switch illustrated in FIG. 1;

FIG. 4(a) is a cross-sectional view of a body of the push-button electrical switch illustrated in FIG. 1 along with a portion of an engaged lamp/switch mount connected thereto;

FIG. 4(b) is a perspective view of the body of the push-button electrical switch looking in a direction from a bottom end towards a top end thereof;

FIG. 5 is a perspective view of a lamp/switch mount of the push-button electrical switch of the invention;

FIG. 6 is a cross-sectional view of the push-button electrical switch illustrated in FIG. 1 taken along a plane perpendicular to the support structure;

FIG. 7 is a schematic of a lamp for use in illuminating the gaming machine push-button switch of the invention;

FIG. 8 is a perspective view of one embodiment lamp of the present invention;

FIG. 9 is a side view of the lamp of the invention with a lower housing portion thereof to expose internal components;

FIG. 10 is a top view of the lamp illustrated in FIG. 9; and

FIG. 11 is a circuit diagram of one embodiment lamp of the invention.

### DETAILED DESCRIPTION OF THE INVENTION

The invention is a push-button type electrical switch. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a push-button type electrical switch. The switch includes a push-button for actuating an electrical switch. In one embodiment, the push-button electrical switch has a light or lamp for illuminating a portion of a body or housing of the push-button electrical switch, preferably that portion adjacent at least a portion of the push-button, thereby permitting easy identification of the location of the push-button by a user. In one embodiment, the push-button electrical switch has a configuration which promotes ease of assembly and disassembly. In one embodiment, the switch has one or more conductive body portions for transmitting electric discharges therethrough to a remote location, such as a supporting structure to which the body is mounted.

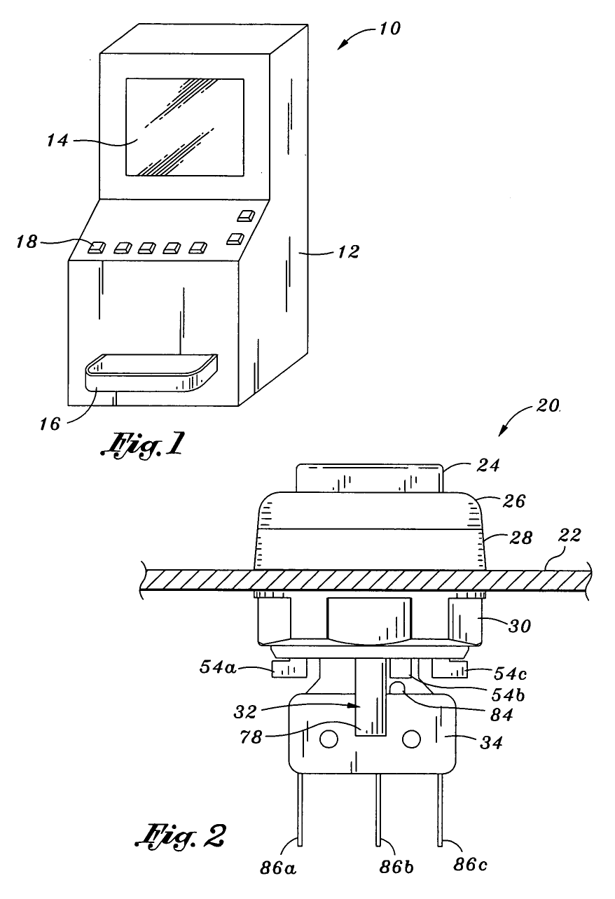

FIG. 1 illustrates a gaming machine 10 configured to present one or more games to a player thereof. In a preferred embodiment, the gaming machine 10 is a wagering type machine, in which a player is required to place a bet and which, upon the occurrence of a predetermined winning event or events, entitles the player to prizes or winnings. As illustrated, the gaming machine 10 includes a housing 12 for enclosing/supporting various components of the gaming machine. The gaming machine 10 includes a display 14 for displaying images of cards or other indicia for use in playing the game. Speakers (not shown) or other devices may be provided for generating sound associated with the game.

Though not shown, the gaming machine 10 may include a bill validator/acceptor for accepting paper currency and/or a coin acceptor for accepting coins. Other means of payment, such as a credit card reader may be provided. An award of winnings in the form of coins may be paid to the player via a coin tray 16. The gaming machine 10 may include a card reader for reading a player tracking card or the like, as is known in the art.

Preferably, the gaming machine 10 includes means for a player to provide input. In one embodiment, this means comprises one or more buttons 18. For example, a plurality of card “hold” or “select” buttons may be provided for permitting a player to hold/select cards in a hand. A deal/draw button may permit a player to indicate that they wish the game to start or to draw replacement cards. A bet button may be provided for a player to select the amount to bet on a particular game.

A game controller (not shown) is provided for controlling the various devices of the gaming machine and for providing game information. For example, the game controller may be arranged to generate video and audio data for presentation by the display and speakers of the gaming machine 10. The game controller may be arranged to detect a signal from the coin acceptor indicating the receipt of coins, and may be arranged to cause a coin delivery mechanism to deliver coins from a coin hopper to the coin tray 16.

It will be appreciated that the gaming machine 10 may have a variety of configurations and the gaming machine 10 illustrated and described above is but an example of a device. In one or more embodiments, the gaming machine 10 may be associated with a network and receive game information remotely and may transmit information, such as payout and game play information, to a remote location.

In one embodiment, one or more of the buttons 18 comprise user-operable push-button switches. One embodiment of a push-button electrical switch 20 of the invention will first be described generally with reference to FIG. 2. As illustrated, the push-button electrical switch 20 may be mounted to a support structure. As illustrated, the push-button electrical switch 20 is mounted to a support structure, such as a panel or housing 22 of a gaming machine (such as housing 12 of the gaming machine 10 illustrated in FIG. 1). In general, the push-button electrical switch 20 includes a push-button lens cap 24 extending from a top portion or end of a button body or housing 26. The body or switch includes an adapter 28 and lock nut 30. As illustrated, the adapter 28 and lock nut 30 are associated with an exterior portion of the body 26. The adapter 28 may be formed integral with the body 26. A lamp/switch mount 32 is connected to the body 26 and extends from a bottom portion or end thereof generally opposite the push-button lens cap 24. An electrical switch 34 is connected to the lamp/switch mount 32.

In the arrangement illustrated, the housing 22 comprises a metal panel forming a portion of a body or housing of the gaming machine. The housing 22 has an aperture therethrough. Preferably, the body 26 extends through the aperture. The aperture is larger than the portion of the body 26 which extends therethrough, but is smaller in dimension than the adapter 28. The adapter 28 is positioned over the body 26 adjacent a top side of the housing 22, obscuring the aperture through which the body extends. The lock nut 30 is affixed to the body 26 from the bottom side of the housing 22. In this manner, the housing 22 is positioned between the adapter 28 and the lock nut 30, securing the push-button electrical switch 20 to the housing 22.

As detailed below, the push-button lens cap 24 extends outwardly from the body 26 for engagement by a user thereof, such as by a player of the gaming machine. When depressed or pushed by a user, the push-button lens cap 24 is arranged to activate/actuate the electrical switch 34. Leads extend from the electrical switch 34, and wires may be connected to the leads and extend to another device, whereby the signal from the electrical switch 34 is used as an input to that device.

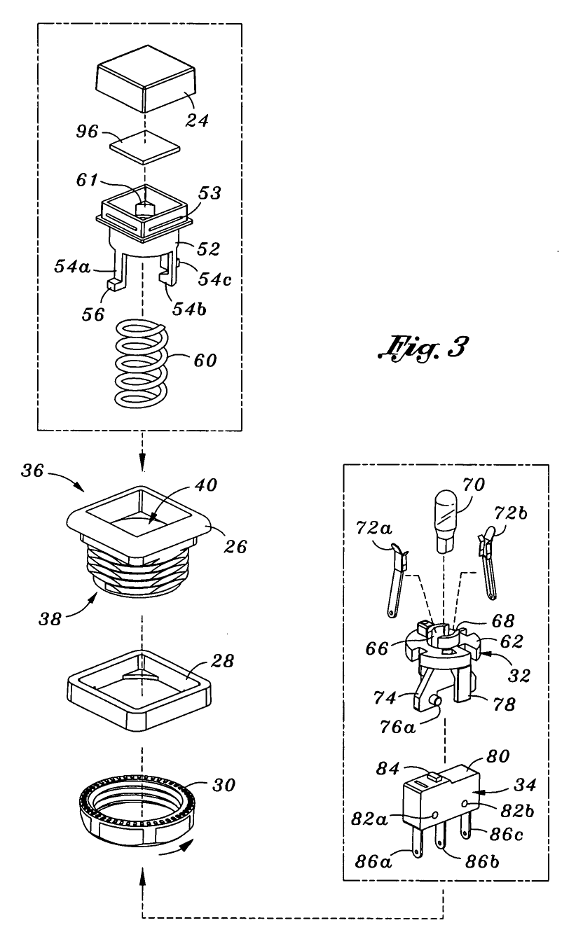

The components and construction of the push-button electrical switch 20 will now be described in detail. As illustrated in FIG. 3, the body 26 serves a supporting/housing function and includes a wall having inner and outer surfaces. In one embodiment, the body 26 is generally tubular and has a top or proximal end 36 and a bottom or distal end 38. A passage 40 extends through the body 26. As illustrated, at its top end 36, the body 26 is generally square, thus defining a generally square periphery of the passage 40. The body 26 may have a variety of other shapes at this location, such as round or rectangular. Preferably, the bottom end of 38 of the body 26 is generally cylindrical, thus defining a generally circular periphery of the passage 40 at that location.

In one or more embodiments, an outer surface of the body 26 is threaded at its bottom end 38. The threads extend upwardly towards the top end 36. The threads are adapted to accept mating threads on the lock nut 30.

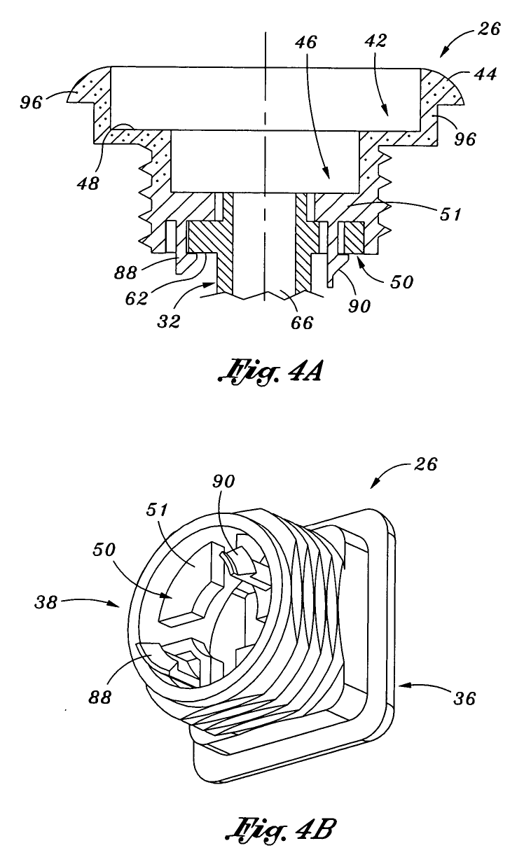

Referring to FIGS. 4(a) and 4(b), the body 26 defines an upper cavity 42 for accepting at least a portion of the push-button lens cap 24. The upper cavity 42 forms a portion of the passage 40 through the body 26. As illustrated, when the push-button lens cap 24 is generally square in peripheral shape, so is the upper cavity 42. As described above, the body 26 defines a periphery around the upper cavity 42 which is also generally square. As illustrated, the body 26 includes an outwardly extending flange 44 in this location. As noted above, the push-button lens cap 24 may be other than square, in which case the body 26 at this location is as well, for example round or rectangular.

A middle cavity 46 is positioned below the upper cavity 42 and also forms a portion of the passage 40. The middle cavity 46 is preferably cylindrical in shape, and has a diameter which is less than the maximum dimension of the upper cavity 42. As a result of the change in size and shape between the upper and middle cavities 42,46, a ledge 48 is defined. As detailed below, the ledge 48 serves as a stop to limit the travel of the push-button lens cap 24 downwardly into the body 26, and serves as a support for a spring.

A lower cavity 50 is positioned below the middle cavity 46 and also forms a portion of the passage 40. The lower cavity 50 is also preferably generally cylindrical in shape. As illustrated, a stop extends inwardly dividing at least a portion of the middle and lower cavities 46,50. Referring to FIG. 4(b), the stop comprises four wall or stop segments 51.

As described above, a push-button lens cap 24 is associated with the body 26, and preferably is located at the top end 36 thereof. At least a portion of the push-button lens cap 24 is adapted to extend from the top end 36 of the body 26 for engagement by a user. Referring to FIG. 3, the push-button lens cap 24 comprises a generally square member having a top surface and one or more sides or members extending downwardly therefrom. The push-button lens cap 24 may have a variety of other shapes, including rectangular and circular.

The push-button lens cap 24 is associated with an actuator 52. The actuator 52 has a first end shaped to accept the push-button lens cap 24 there over. When the push-button lens cap 24 is square, preferably so is the first end of the actuator. Likewise, when the push-button lens cap 24 has other shapes such as rectangular or circular, the first end of the actuator 52 may be as well. Notably, the first end of the actuator 52 and the push-button lens cap 24 need not be the same shape, as long as the connecting function between the two is facilitated. As illustrated, one or more tabs 53 are located on the outside of the first end of the actuator 52 for use in securing the push-button lens cap 24 to the actuator 52.

The actuator 52 has a generally cylindrical main portion adapted to fit within the middle cavity 46 of the body 26. Preferably, three legs 54a,b,c extend downwardly from the periphery of the main portion of the actuator 52 in a direction opposite its first end. A pair of the legs 54a,54c are preferably located about 180 degrees apart. The third leg 54b is positioned there between. As illustrated, the third leg 54b is preferably located nearer one of the legs 54c than the other of the legs54a.

The opposing legs 54a,54c each have a catch 56 extending outwardly therefrom. Preferably, each catch 56 extends in a direction generally radially out in a direction perpendicular to an axis extending through the actuator. Referring to FIG. 2, when the actuator 52 is positioned in the body 26, the legs 54a,b,c extend through spaces between the stop segments 51 of the body 26. When so positioned, the catches 56 engage a lower rim of the body 26, preventing further upward movement of the actuator 52.

A foot 58 is located on the end of the third leg 54b. As described in more detail below, the foot 58 is adapted to engage a button of the electrical switch 34 for actuating the switch. As illustrated, the foot 58 extends radially inward from the third leg 54b.

A spring 60 is positioned inside of the body 26 and engages both the body 26 and the actuator 52. In a preferred embodiment, the spring 60 is a helical spring. A first end of the spring 60 rests against the top surface of the stop segments 51 of the body 26. The second end of the spring 60 is positioned within the actuator 52 and rests against a stop 61 therein. So arranged, the spring 60 has the natural tendency to urge the actuator 52 upwardly to the point where further upward travel is limited by the catches 56. The urging of the actuator 52 upwardly also urges the push-button lens cap 24 attached thereto upwardly. When pressed by a user, the push-button lens cap 24 moves the actuator 52 downwardly against the biasing force of the spring 60, compressing the spring.

The lamp/switch mount 32 is connected to the body 26 at its bottom end 38. The lamp/switch mount 32 will now be described in detail with reference to FIG. 5. The lamp/switch mount 32 has a generally disc-shaped main portion 62. The main portion 62 has three cut-out areas 64a,b,c permitting passage of the legs 54a,b,c of the actuator 52 therethrough.

A passage 66 extends generally centrally through (i.e., along a central axis extending generally perpendicular to a plane in which the main portion 62 extends) the main portion 62. A lamp stand 68 extends upwardly from a top surface of the main portion 62 and downwardly from a lower surface of the main portion, defining a generally lower closed end. In general, the lamp stand 68 forms extended portions of the passage 66, thereby defining a socket area for accepting therein a portion of a lamp 70 (see FIG. 3). As described below, in a preferred embodiment, the lamp 70 is a LED light having a polarity matching module. The lamp 70 may have other configurations, however, such as an incandescent bulb or the like. First and second contacts 72a,b are also located in the passage 66. The first and second contacts 72a,b contact leads or contacts on the lamp 70. The contacts 72a,b extend through the lower closed end of the lamp stand 68 for connection to appropriate power wires for powering the lamp.

A switch mount 74 extends below the main portion 62 of the lamp/switch mount 32. The switch mount 74 is offset from the central axis. In one embodiment, the switch mount 74 extends from the lamp stand 68. The switch mount 74 includes first and second spaced pins 76a,b. A lock 78 extends downwardly from the main portion 62. The lock 78 is spaced apart from the pins 76a,b, defining a space in which the electrical switch 34 may be located.

Referring to FIG. 3, the electrical switch 34 has a generally closed housing 80. The electrical switch 34 may have a variety of shapes and configurations. As illustrated, the housing 80 is generally rectangular. First and second passages 82a,82b extend through the housing 80 from side to side. The passages 82a,b are adapted to accept the first and second pins 76a,76b of the lamp/switch mount 32.

A button 84 extends upwardly from a top surface of the housing 80. The button 84 preferably actuates an electrical switch within the electrical switch 34. In one embodiment, the electrical switch 34 is a two-position switch. The workings of such electrical switches 34 are well known. As is common in such a two-position electrical switch 34, the electrical switch 34 includes three leads or contacts 86a,b,c. The position of the electrical switch 34 determines which of the leads are “hot” (one being for ground).

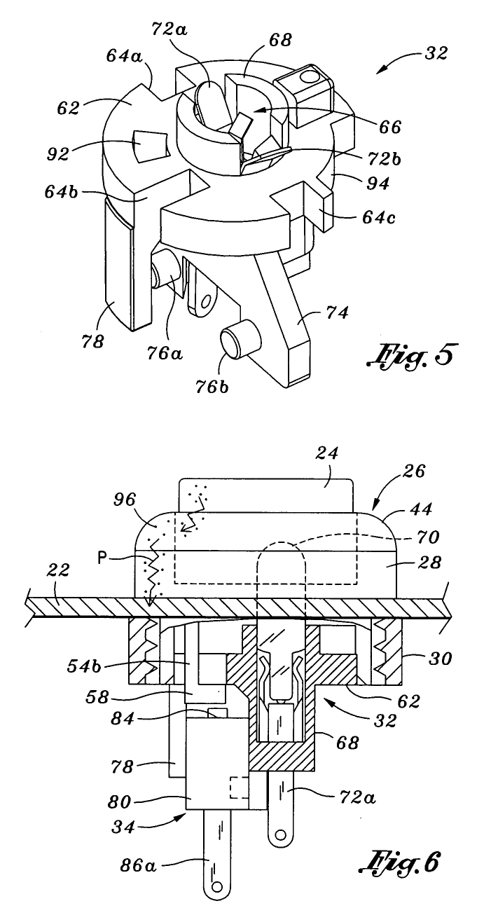

Referring to FIG. 6, when the electrical switch 34 is mounted to the lamp/switch mount 32 the pins 76a,b extend into the passages 82a,b. The lock 78 presses against the opposite side of the housing 80 of the electrical switch 34, maintaining the pins 76a,b in engagement with the passages 82a,b, securely mounting the electrical switch 34.

When so mounted, the foot 58 of the second leg 54b of the actuator 52 is positioned adjacent the button 84 of the electrical switch 34. When a user depresses the push-button lens cap 24, the actuator 52 is moved downwardly, causing the foot 58 to engage the switch button 84. This actuates the electrical switch 34.

Most importantly, in accordance with the invention there is provided an advantageous mounting arrangement for removably connecting the lamp/switch mount 32 to the body 26. Referring to FIGS. 4(a) and 4(b), first and second latches 88,90 extend from the bottom end 38 of the body 26. The latches 88,90 extend from the stop segments 51 of the body 26. Each latch 88,90 generally comprises a member extending outwardly from the stop segment and includes a catch. As illustrated, the latches 88,90 are positioned generally 180 degrees apart, with the catches facing generally in the same direction.

The lamp/switch mount 32 includes a passage 92 through the main portion 62. The passage 92 accepts the latch 90 therethrough. A cut-out or recess 94 is provided in the periphery of the main portion 62 of the lamp/switch mount 32.

Referring to FIG. 4(a), the lamp/switch mount 32 is arranged to be mounted in abutting relationship to the stop segments 51 at the bottom end 38 of the body 26. The top surface of the main portion 62 of the lamp/switch mount 32 is abutted against the lower surface of the stop segments 51 of the body 26. In this position, the latch 90 extends through the passage 92 in the lamp/switch mount 32, with the catch of the latch 90 engaging the lower portion of the main portion 62 of the lamp/switch mount 32. At the same time, the latch 88 extends along the cut-out area 94 in the main portion 62 of the lamp/switch mount 32, with the catch thereof also engaging the lower portion of the main portion 62 of the lamp/switch mount 32.

Preferably, as illustrated in FIG. 4(a), the latches 88,90 are arranged to press the lamp/switch mount 32 both upwardly against the stop segments 51, and radially outwardly against the inside wall of the body 26 at its bottom end 38. Importantly, the latches 88,90 are slightly flexible, permitting a user to bend them out of engagement with the lamp/switch mount 32, thereby permitting the lamp/switch mount 32 to be removed from engagement with the body 26.

In one or more other embodiments, other means may be provided for removably securing the lamp/switch mount 32 to the body 26. Preferably, the securing means includes at least one member which is accessible by a user for manipulation in unlocking or removing the lamp/switch mount 32 from the body 26. There may be only a single latch or more than one latch. The latch(es) may engage the lamp/switch mount 32 in a variety of manners. For example, the lamp/switch mount 32 need not include passages or cutout areas. The lamp/switch mount 32 may include a trough in the lower surface or in a side surface for engagement by a portion (such as a catch) of the latch(es). In one embodiment, a threaded rod may extend from the body 26 and through a passage/slot in the lamp/switch mount 32. A nut may be threaded onto the rod to engage the lamp/switch mount 32 with the body 26.

In one embodiment, the latches 88, 90 may extend form the wall forming the body 26 instead of or in addition to the stop segments 51. In another embodiment, rotating lock members may be associated with the body 26 and moved into a locking position when the lamp/switch mount 32 is pressed into engagement therewith, and rotated out of the locking position to permit removal/disconnection of the lamp/switch mount 32 from the body 26. In general, it is desired that a release for the locking mechanism be accessible to the user.

The various components of the push-button electrical switch 20 may be constructed from a wide range of materials. In one embodiment, the push-button lens cap 24, actuator 52, body 26, adapter 28, lock nut 30, and lamp/switch mount 32 comprise plastic or a similar material conveniently constructed in a molding or extrusion process. The contacts 72a,72b and spring 60 preferably comprise metal members. In one or more embodiments, the various components may have a variety of colors.

In one embodiment of the invention, at least a portion of the body 26 around the push-button lens cap 24 is arranged to illuminate or be illuminated. In this manner, the location of the push-button lens cap 24 may be easily identified by a user. In a preferred embodiment, the body 26 is constructed from a transparent or generally transparent material, such as clear plastic, instead of traditional black polypropylene. Light emitted by the lamp 70 passes through the body 26, thereby illuminating the body 26, including the peripheral portion thereof at the top end 36 around the push-button lens cap 24.

In one embodiment, to provide significant contrast between the push-button lens cap 24 and the body 26, the push-button lens cap 24 is arranged to generally not transmit light emitted by the lamp 70. In one embodiment, the push-button lens cap 24 may be constructed of an opaque material. In another embodiment, a shield, such as plastic plate, may be located within the push-button lens cap 24. In this embodiment, the push-button lens cap 24 is generally not illuminated, but the surrounding body 26 is, whereby the illuminated body 26 generally serves to identify the extent/location of the push-button lens cap 24. In a preferred embodiment, as illustrated in FIG. 3, a legend plate 96 is located inside of the push-button lens cap 24. The legend plate 96 may have lettering printed thereon which is readable through the push-button lens cap 24. For example, the legend plate 96 may be printed with “deal/draw,” “bet one” or other words, numbers or symbols. In one embodiment, the legend plate 96 permits light illuminated by the lamp 70 to pass therethrough to render the lettering or other printing more visible. For example, the legend plate 96 may be a plastic plate of any of a variety of colors (even clear) having printing, such as black or other colored lettering.

In accordance with another aspect of the invention, the push-button electrical switch 20 is arranged to divert or ground electro-static discharge (ESD). In one or more embodiments of the invention, one or more of the components of the push-button electrical switch 20 are adapted to conduct electrical energy to the housing 22 of the gaming machine or other support structure or remote location, and away from the circuitry of the lamp 70 and electrical switch 34.

In one embodiment, as illustrated in FIG. 6, a path of electrical conduction P is defined from an external portion of the push-button electrical switch 20 to the housing 22 or other grounding element. In one or more embodiments, this pathway is defined by an electrically conductive material located in the push-button electrical switch 20. In one embodiment, the body 26, adapter 28, and/or lock nut 30 are constructed from plastic having a conductive carbon material 96 interspersed therein (see FIGS. 4A and 6). The interspersed conductive carbon 96 defines a pathway through the component to the housing 22 or other ground. Preferably, sufficient conductive carbon is provided that the path of least resistance to the electrical energy is defined through the component to ground rather than through the component to the electrical switch 34 or lamp 70, and thereon to the associated circuitry.

It will be appreciated that in order to provide an effective pathway P to ground, the housing 22 or other supporting structure may need to be specially configured. In one embodiment, the housing 22 may comprise a metal panel which is painted (such as powder coated). In such an embodiment, it is preferred that an area of contact be provided between the body 26, adapter 28, lock nut 30 or other component of the push-button electrical switch 20 directly with the metal of the housing 22.

In one embodiment, a metal strip or the like maybe connected to the push-button electrical switch 20, such as sandwiched between the adapter 28 and housing 22 or lock nut 30 and housing 22, with the metal strip extending to ground.

In another embodiment, the pathway P through the push-button electrical switch 20 to ground may comprise other than dispersed particles 96. In one embodiment, a wire may be embedded in the body 26 and extend from a top outer surface thereof to an contact with ground, such as the interface with the housing 22. Other interspersed materials may be used. An advantage of the interspersed material is that the location or proximity of the user's touch or approach to the push-button electrical switch 20 need not then coincide with a specific location of the path to ground (as in the case of an embedded wire), since multiple paths to ground are provided.

In other embodiments, a layer of conductive material may be located on the one or more components of the push-button electrical switch 20. For example, a thin layer of conductive metal may be deposited on the exterior of the body 26 and/or adapter 28.

In one embodiment, the push-button lens cap 24 may be conductive. In such event, it is desired that the actuator 52 be insulating so that electrical energy is transferred from the push-button lens cap 24 through the body 26 to ground, and not to the switch/lamp circuits.

Assembly and use of the push-button electrical switch 20 of the invention will now be described. Referring to FIG. 3, the lamp 70 is installed into the lamp/switch mount 32 along with the contacts 72a,b. The electrical switch 34 is connected to the lamp/switch mount 32.

The push-button lens cap 24 is connected to the actuator 52. The spring 60 is inserted into the top end 36 of the body 26 and the actuator 52 is guided over the top end of the spring. The actuator 52 is pressed downwardly, compressing the spring 60 until the catches 56 of the legs 54a,54c of the actuator 52 engage the bottom end 38 of the body 26.

The lamp/switch mount 32 is then connected to the body 26. As described above, the lamp/switch mount 32 is aligned with the legs 54a,b,c and latches 88,90 and is pressed upwardly. The legs 54a,b,c extend through the recesses 64a,b,c in the lamp/switch mount 32. The latch 90 extends through the passage 92, and the latch 88 extends along the cut-out 94. Upon further upward movement, the catches on the latches 88,90 extend over the bottom surface of the main portion 62 of the lamp/switch mount 32, locking it to the body 26.

The push-button electrical switch 20 may be conveniently mounted to the housing 22. First, the adapter 28 is extended over the bottom end 38 of the body 26 and is moved upwardly as far as possible. Next, the bottom end 38 of the body 26 is passed through an aperture in the housing 22 until the adapter 28 rests upon or abuts the housing 22. The locking nut 30 is then engaged with the threads on the outer surface of the body 26 from the bottom end 38. The locking nut 30 is threaded upwardly until it engages the housing 22.

Appropriate wiring (not shown) is attached to the contacts 72a,72b for providing power to the lamp 70. Appropriate wiring (not shown) is also attached to the leads 86a,b,c of the electrical switch 34.

In use, a user depresses the push-button lens cap 24. The push-button lens cap 24 moves the actuator 52 downwardly against the force of the spring 60. Sufficient downward movement causes the foot 58 of the leg 54b to engage the switch button 84, actuating the electrical switch 34. Upon release of the user-applied pressure or force, the spring 60 moves the actuator 52 and push-button lens cap 24 upwardly.

A significant advantage of the push-button electrical switch 20 is that an electro-static discharge (ESD) from the player is routed away from the circuitry of the push-button electrical switch 20, avoiding many problems. In accordance with the invention, when a player touches (or comes sufficiently close to the push-button electrical switch 20 that a discharge may arc through the air space and bridge to the switch) the push-button electrical switch 20, the discharged electrical energy is routed to the housing 22 or a remote location, grounding the discharge. In the preferred embodiment, the discharge is routed through the conductive material in the body 26, adapter 28 and/or lock nut 30 to the housing 22. This path routes the electrical energy away from the lamp circuit or the switch circuit.

In accordance with the invention, a push-button electrical switch 20 is provided which is simple to assemble and disassemble. In particular, replacement of the lamp 70 is facilitated. In the event the lamp 70 burns out and needs replacing, the lamp/switch mount 32 is easily disengaged from the body 26, providing access to the lamp 70 for replacement. In order to disengage the lamp/switch mount 32, a user need only bias the catches of the latches 88,90 out of engagement with the lamp/switch mount 32. Then, the user may move the lamp/switch mount 32 downwardly with respect to the body 26 for access to the lamp 70.

As another aspect of the invention, the push-button electrical switch 20 has an illuminated body 26 surrounding the user-actuatable push-button lens cap 24. The illuminated body 26 aids in defining to a user the location of the push-button lens cap 24.

Another aspect of the invention will be described primarily with reference to FIGS. 7-11. One aspect of the invention is an improved light or lamp for use in illuminating a push-button type switch, such as that described above. It will be appreciated that the light or lamp may be used in other applications, though the lamp is particularly suited for and has particular applicability to a gaming machine push-button switch.

One embodiment of the lamp 70 is illustrated in FIG. 7. As illustrated, the lamp has a light emitting element 98, a polarity matching module 100, and one or more inputs I. The light-emitting element 98 comprises an element which is configured to emit light at one or more times. As described below, the light emitting element 98 comprises a light emitting diode. The element 98 may comprise other elements, such as an incandescent bulb.

The polarity matching module 100 comprises hardware and/or software configured to cause the polarity of an electrical output to remain constant, or the same, regardless of the polarity of the input. One embodiment of such a module 100 is described in detail below.

The inputs I preferably comprise leads, such as electrical wires, for transmitting electrical current from a power supply. As illustrates, the inputs I transmit the electrical current to the polarity matching module 100. The output of the polarity matching module 100 is preferably provided to the light-emitting element 98, causing it to emit light.

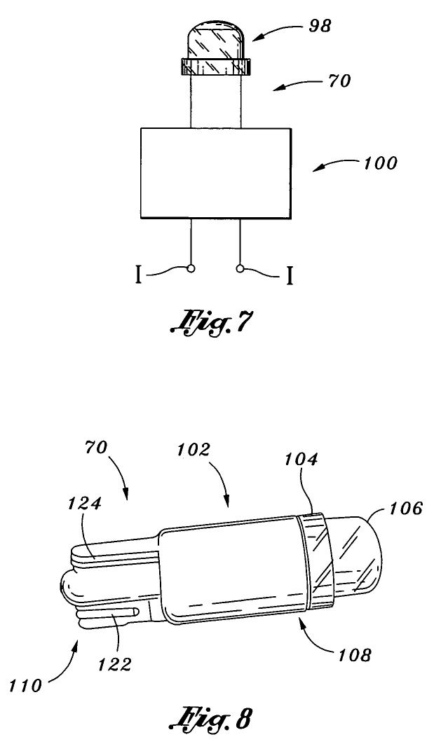

One preferred embodiment of the invention will be described with reference to FIGS. 8-11. As illustrated in FIG. 8, the lamp 70 includes a housing 102, a base 104, and a cover 106. Various of the components of the lamp 70 are contained within the housing 102 and cover 106, and supported by the base 104.

In one embodiment, the housing 102 comprises a molded plastic body which defines an interior area for housing various of the components of the lamp 70. As illustrated, the housing 102 has a top or first end 108 and a bottom end 110. As illustrated, a portion of the housing 102 near the top end 108 is generally cylindrical in shape. A portion of housing 102 near the bottom end 110 is more planar in shape, and is preferably configured to fit within an electrical socket, such as the passage/socket 66 of the switch 20 described above.

As illustrated, when assembled, the top end 108 of the housing 102 abuts the base 104. In one embodiment, the base 104 is a generally disc-shaped body. The base 104 may be constructed of a variety of materials, such as plastic.

The cover 106 preferably comprises a transparent or translucent body which houses the light-emitting element of the lamp 70. In one embodiment, the cover 106 defines a generally hollow interior space in which the element is mounted. In another embodiment, the cover 106 may be formed with the element therein, such as in a molding process. The cover 106 may be constructed of a variety of materials, such as plastic or glass. Preferably, the cover 106 is mounted to and supported by the base 104.

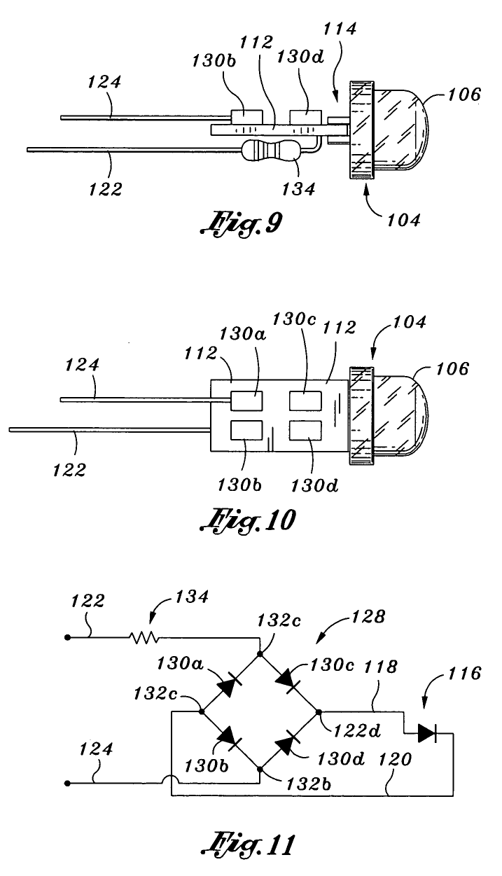

As illustrated in FIGS. 9 and 10, the lamp 70 includes a circuit board 112 which includes or supports various elements of the lamp 70, as described below. As illustrated, the board 112 is generally planar. Preferably, the board 112 is connected to the base 104 and extends therefrom generally opposite the cover 106. The board 112 and housing 102 are sized and shaped so that the board 112 fits within the housing 102.

In the embodiment illustrated, the board 112 is connected to a mount 114 associated with the base 104. As illustrated, the mount 114 comprises a pair of spaced-apart extensions. The board 112 is press-fit between the extensions 114.

As described, the board 112 supports a number of elements of the lamp 70. FIG. 11 illustrates is a circuit diagram of a preferred embodiment of the lamp 70. In one embodiment, various of the elements of this circuit are supported by the board 112.

Referring to FIG. 11, in a preferred embodiment, the lamp 70 of the invention is an LED type lamp. As such, the light-emitting element thereof is a light-emitting diode 116. The diode 116 has one or more inputs. In one embodiment, the inputs comprise a first diode lead 118 and a second diode lead 120. A flow of electricity is provided to the diode 116 via these inputs or leads 118,120.

As described above, the lamp 70 includes main inputs. As illustrated, the main inputs comprises a first main lead 122 and a second main lead 124. The polarity matching module is located between the main inputs and the diode inputs. In a preferred embodiment, the polarity matching module comprises a diode bridge 128.

As illustrated, the diode bridge 128 comprises four diodes 130a,b,c,d positioned between four nodes 132a,b,c,d. The diode inputs or leads 116,118 are associated with two opposing nodes 132a,132d, and the main inputs or leads 122,124 are associated with the other two opposing nodes 132b,132c. The configuration of the diode bridge 128 is such that regardless of the polarity of the power source applied to the main inputs, the polarity of the output of the bridge 128 (and thus the polarity to the diode inputs or leads 122,124) is always the same.

In a preferred embodiment, a resistor 134 is associated with one of the main leads 122 and its associate node 132c (the resistor 134 could be associated with the other lead 124 and its associated node 132b). The configuration, including the resistance value of the resistor may vary depending on the application.

FIGS. 9 and 10 illustrate one physical embodiment of the circuit illustrated in FIG. 11. As illustrated, the diodes 130a-d are mounted to the circuit board 112. Though not shown, the diodes 130a-d are in electrical or conductive communication, such as via printed, embedded or formed conductive paths.

In one embodiment, the main leads 122,124 comprise physical wires. As one aspect of the invention, to minimize the profile of the lamp 110, the diodes 130a-d are mounted to one side of the circuit board 112 and the resistor 134 is positioned on the opposing side of the circuit board 112.

Though not illustrated, the light-emitting diode 116 is positioned in or under the cover 106. The light-emitting diode 116 is in electrical communication with the diodes 130a-d, such as by wires or other leads, contacts or the like.

When positioned in the housing 102, the leads 122,124 preferably extend from the second end 110 thereof. In one embodiment, apertures (not shown) are provided in the housing 102 for this purpose. In one embodiment, the leads 122,124 extend from the second end 110 of the housing 102 and then fold back on either side thereof and extend towards the first end 108 of the housing, forming contact areas.

In use, the lamp 70 of the invention is connected to a power supply. In a preferred embodiment, the lamp 70 is located in the socket of a switch, such as the switch 20 described above. When the lamp 70 is inserted in to the switch 20 described above, the leads 122,124 thereof contact the contacts 72a,72b, providing electrical connectively to the power source with which the switch 20 is associated. This causes the lamp 110 to emit light, lighting the switch 20 as described in detail above.

The lamp 70 of the invention has particular advantages. In particular, the lamp 70 maybe connected to the power supply, such as by insertion into the socket of the switch 20, without regard to the polarity of the provided input. For example, the polarity of contact 72a may be (+) and the polarity of contact 72b may be (−) or, alternatively, the polarity of contact 72a may be (−) and the polarity of contact 72b may be (+). Regardless of the applied voltage or power to the inputs of the lamp 70, however, the polarity of the output of the polarity matching circuit 100/diode bridge 128 is the same. Generally, a light emitting diode will only illuminate in a particular polarity configuration (and will not illuminate in the opposing configuration). As such, it is desired that the polarity matching module/diode bridge and light emitting diode be arranged so that the output of the polarity matching module/diode bridge, as applied to the light-emitting diode, always causes the light to illuminate.

In practice, this aspect of the invention has numerous advantages. As will be appreciated, when a technician replaces a lamp 70 of the invention, the technician need not know the polarity of the contacts 72a,72b, and thus need not be concerned with the particular orientation of the lamp 70 in the socket. In other words, it is irrelevant which input or lead 122,124 of the lamp 70 contacts which contact 72a,72b, even though the polarity at the contacts 72a,b differs. Thus, the technician may simply insert the lamp 70 regardless of orientation, making lamp replacement much easier and much less time consuming.

One common problem in the gaming industry is associated with electrical switch bulb replacement. Due to the number of switches and associated bulbs, bulb replacement is an ongoing, continuous effort. The present invention avoids problems which would be associated with a technician replacing a lamp which is sensitive to the polarity of the power supply and which might either result in damage to the bulb or power supply, or result in a blown fuse, all of which would significantly increase the cost and time associated with bulb replacement. The lamp of the present invention avoids risks of these types of problems.

It will be understood that the above described arrangements of apparatus and the method therefrom are merely illustrative of applications of the principles of this invention and many other embodiments and modifications may be made without departing from the spirit and scope of the invention as defined in the claims.

We claim:

1. A gaming machine push-button actuatable electrical switch comprising:
a button body for mounting to a support structure of a gaming machine, said button body configured to accept a lamp and provide power to an input of said lamp;
a switch connected to said button body;
an push-button mounted for movement relative to said button body; and
an actuator, said actuator configured to actuate said switch in response to the actuation of said push-button;
said lamp comprising a light emitting element and a polarity matching module, said light emitting element configured to illuminate at least a portion of said switch when power is provided thereto, said polarity matching module providing power to said light emitting element with a fixed polarity regardless of a polarity of power provided to said input of said lamp.

2. The gaming machine push-button actuatable electrical switch in accordance with claim 1 wherein said polarity matching module comprises a diode bridge.

3. The gaming machine push-button actuatable electrical switch in accordance with claim 2 wherein said input of said lamp comprises a pair of electrical leads leading to said diode bridge.

4. The gaming machine push-button actuatable electrical switch in accordance with claim 3 wherein a resistor is positioned along one of said leads.

5. The gaming machine push-button actuatable electrical switch in accordance with claim 2 wherein said lamp includes a circuit board and diodes comprising said diode bridge are associated with said circuit board.

6. The gaming machine push-button actuatable electrical switch in accordance with claim 5 wherein said circuit board is generally planar and has a first side and a second side and said diodes are located at said first side.

7. The gaming machine push-button actuatable switch in accordance with claim 6 wherein a resistor is located on a lead leading to said diode bridge at said second side of said circuit board.

8. The gaming machine push-button actuatable switch in accordance with claim 5 wherein said circuit board is located in a housing.

9. The gaming machine push-button actuatable switch in accordance with claim 1 wherein said light emitting element comprises a light emitting diode.

10. The gaming machine push-button actuatable switch in accordance with claim 1 wherein said light emitting element comprises a light emitting diode, said polarity matching module comprises a diode bridge, said lamp input comprises a pair of leads leading to said diode bridge, said light emitting element is connected to the output of said bridge, diodes comprising said diode bridge are associated with a circuit board and said light emitting element is located under a cover.

11. The gaming machine push-button actuatable switch in accordance with claim 10 wherein said lamp includes a housing in which said circuit board is located, at least a portion of said leads extending from said housing.

12. The gaming machine push-button actuatable switch in accordance with claim 11 wherein said lamp includes a base, said light emitting diode mounted to a first side of said base and said circuit board mounted to a second side of said base.

13. A method of changing a lamp of a gaming machine push-button actuatable switch comprising:
removing a lens cap of a push-button of said switch;
removing an existing lamp from a socket defined by a body of said switch;
inserting a new lamp into said socket defined by said body of said switch, said new lamp comprising a polarity matching module having an output connected to a light emitting diode and a pair of inputs leading to said polarity matching module, said inserting including placing said inputs of said lamp into contact with electrical contacts of said switch without regard to the polarity of the power applied to said contacts of said switch.

14. The method in accordance with claim 13 including the step of reconnecting said lens cap after said new lamp is inserted.

15. The method in accordance with claim 13 wherein said lamp includes a housing having a first end and a second end, said inputs comprise a pair of leads, at least a portion of said leads extending from said housing at said second end, said second end of said housing configured to fit within said socket in either a first position or a second position in which said leads will contact said contacts.
